(19) United States
(12) Patent Application Publication
(10) Pub. No.: US 2007/0227008 A1
(43) Pub. Date: Oct. 4, 2007

(54) Razors

(76) Inventors: Andrew Zhuk, Acton, MA (US); Weili Yu, Medfield, MA (US); Hoang Mai Trankiem, Boston, MA (US); Neville Sonnenberg, Newton, MA (US); Kevin L. Powell, Hants (GB); Yiqian Eric Liu, Lexington, MA (US); Robert L. Lescanec, Boston, MA (US); Steve S. Hahn, Wellesley, MA (US); Joseph A. DePuydt, Quincy, MA (US); Alan Crook, Tadley Hants (GB); Cinzia Simonis Cloke, Arlington, MA (US)

Correspondence Address: FISH & RICHARDSON P.C., P.O. BOX 1022, MINNEAPOLIS, MN, 55440-1022, US

(21) Appl. No.: 11/391,762

(22) Filed: Mar. 29, 2006

(51) Int. Cl. B26B 21/00

(52) U.S. Cl. 30/50

(57) ABSTRACT

Multi-blade razors are provided. The razors include blades having different tip radii and thus different relative sharpness.

### TECHNICAL FIELD

This invention relates to razors, more particularly to multi-blade razors, and to blade units for such razors.

### BACKGROUND

In shaving, it is desirable to achieve a close shave, while also providing good shaving comfort and avoiding nicks and cuts. Factors that affect shaving performance include the frictional resistance between the blade edge(s) and the skin and sharpness of the blade edge(s), both of which effect the cutter force applied by the blade(s) to the hair.

Another factor that affects shaving performance and blade wear is the blade exposure, i.e., the extent to which the blade tip extends beyond a plane defined, as will be discussed below, between two adjacent skin contact points of the razor. Blades can be positioned with a neutral exposure (the blade tip in the plane), a positive exposure (the blade tip extending beyond the plane), or a negative exposure (the blade tip is recessed behind the plane). Negative exposures are possible because skin is deformable and thus “flows” into the area behind the plane. More positive exposures will tend to give a closer shave, but may also present more danger of nicks and cuts. In many multi-blade razors the different blades are positioned at different exposures. As a result, the blades contact the skin differently and tend to wear at different rates.

### SUMMARY

The invention features multi-blade razors in which the different blades have different tip radii, and thus have different relative sharpness. The tip radii of the different blades can be selected to provide the razor with desired performance characteristics. In some implementations, the blades are positioned at different exposures.

Tip radius may be measured by estimating the radius of the largest circle that may be positioned within the ultimate tip of the edge when the ultimate tip is viewed under a scanning electron microscope at magnifications of 50,000×. The blade is edge tilted at 30 degrees from the incoming electron beam source in the plane of the blade.

Preferred razors exhibit a good balance of shaving closeness and comfort, with minimal nicks and cuts even for users susceptible to nicking.

In several aspects, the invention features razors that include a safety razor blade unit comprising a guard, a cap, and first, second and third blades with parallel sharpened edges located between the guard and cap.

In a first aspect, the blades have first, second and third tip radii, respectively, at least two of the three blades have different tip radii, and the first blade is closest to the guard and has a tip radius greater than the tip radius of at least one of the second and third blades.

In a second aspect, the first blade is closest to the cap, the third blade is furthest from the cap, and the second blade is disposed between the first and third blades, the blades have first, second and third tip radii, respectively, at least two of the three blades have different tip radii, and the second blade and third blades each have a tip radius greater than the tip radius of the first blade.

In a third aspect, again the first blade is closest to the cap, the third blade is furthest from the cap, the second blade is disposed between the first and third blades, the blades have first, second and third tip radii, respectively, and at least two of the three blades have different tip radii, but in this case the second blade has a tip radius greater than the tip radii of each of the first and third blades.

Some implementations include one or more of the following features. In the first aspect discussed above, the second blade may have a tip radius greater than, equal to or less than that of the third blade, and the first blade may have a tip radius greater than that of the second or third blade. In some cases, the first and third blades may have approximately equal tip radii.

The razor may include four blades having parallel sharpened edges. If the third and fourth blades are positioned in third and fourth positions from the guard respectively, the fourth blade may have a greater tip radius than the third blade. In some cases, the tip radius of the third blade may be approximately equal to the tip radius of the first blade and the tip radius of the second blade may be approximately equal to the tip radius of the fourth blade. The tip radius of the second blade may be greater than the tip radius of the third blade. The razor may include five or more blades.

The invention also features blade units having the characteristics described herein.

In other aspects, the invention features methods of making razors. For example, in one aspect, the invention features a method of making a razor, including treating a first blade to provide a tip having a first radius of curvature; treating a second blade to provide a tip having a second radius of curvature; treating a third blade to provide a tip having a third radius of curvature; wherein at least two of the radii of curvature are different; and assembling the first, second and third blades in a cartridge comprising a guard and a cap, wherein the blades are positioned having parallel edges and have different blade exposures.

In other aspects, the invention features methods of shaving using the razors described herein.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a cross-sectional view of a blade unit.

Like reference symbols in the various drawings indicate like elements.

### DETAILED DESCRIPTION

In various implementations, different blades of the razor have different tip radii and thus different relative sharpness. The blade sharpness may be quantified by measuring cutter force, which correlates with sharpness. Cutter force is measured by the wool felt cutter test, which measures the cutter forces of the blade by measuring the force required by each blade to cut through wool felt. The cutter force of each blade is determined by measuring the force required by each blade to cut through wool felt. Each blade is run through the wool felt cutter 5 times and the force of each cut is measured on a recorder. The lowest of 5 cuts is defined as the cutter force.

The combination and positioning of sharper and duller blades can be selected so as to provide a razor with desired performance characteristics. Generally, relatively sharper blades will cut hair and relatively duller blades will tend to pull hair up so that it can be cut closer to the skin by the following blade(s). However, the manner in which a particular blade functions will depend on its exposure as well as on its sharpness.

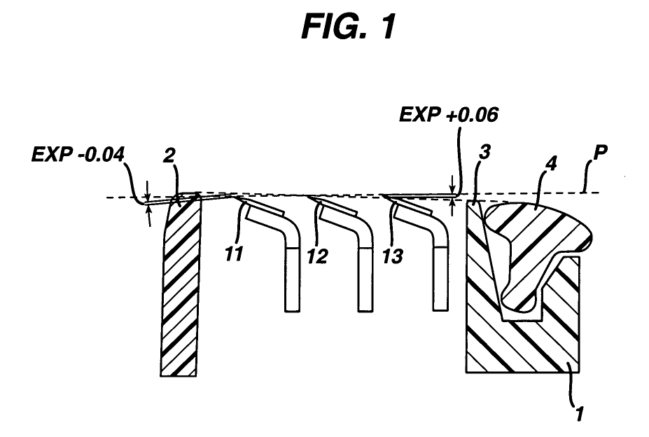

Referring to FIG. 1, a blade unit of a razor cartridge includes a frame 1 defining a guard 2, and a cap 3. As shown the cap comprises a lubricating strip 4 mounted on the frame. The strip may be of a form well known in the art. Carried by the frame are primary, secondary and tertiary blades 11,12,13 having parallel sharpened edges. The blades may be supported firmly by the frame to remain substantially fixed in the positions in which they are depicted (subject to any resilient deformation which the blades undergo under the forces applied against the blades during shaving). Alternatively the blades may be supported for limited movement against spring restoring forces, e.g. in a downward direction as viewed in the drawings.

In the blade unit of FIG. 1, the edges of all three blades lie in a common plane P. The blade exposure is defined to be the perpendicular distance or height of the blade edge measured with respect to a plane tangential to the skin contacting surfaces of the blade unit elements next in front of and next behind the edge. Therefore, for the three-bladed blade unit shown in FIG. 1, the exposure of the first or primary blade is measured with reference to a plane tangential to the guard and the edge of the second blade, and the exposure of the third or tertiary blade is measured with reference to a plane tangential to the edge of the second blade and the cap. Blade exposure may be neutral, if the tip is in the plane; positive, if the tip extends beyond the plane towards the user; or negative, if the tip is recessed behind the plane, away from the user. Generally, the greater the exposure, the closer the blade will tend to shave, but also the more likelihood that the blade will nick or cut the user. Blades with negative exposures will nonetheless cut hair, due to the deformable nature of skin and thus the tendency of the skin bulge to flow into the recessed area and towards the blade.

In the embodiment shown in FIG. 1, the primary blade 11 has a negative exposure (e.g., −0.04 mm), the exposure of the secondary blade 12 is zero, and the exposure of the tertiary blade 13 is positive (e.g., +0.06 mm), with the edges of all three blades lying in plane P. Thus, there is a progressive increase in blade exposure from the leading blade 11 to the trailing blade 13. Razor cartridges having blades with progressively different exposures are described in U.S. Pat. No. 6,212,777, the complete disclosure of which is hereby incorporated by reference herein.

In one embodiment, the primary blade 11, which has a negative exposure, has a smaller tip radius and therefore is sharper and exhibits a lower cutter force than the secondary blade 12. Preferably, the tertiary blade 13 has a smaller tip radius than the secondary blade, e.g., a tip radius approximately equal to the tip radius of the primary blade or in between the tip radii of the primary and secondary blades. In this case, the primary blade will tend to cut hair, and the tertiary blade will cut the hair that is pulled by the secondary blade. The inclusion of the relatively dull secondary blade tends to reduce the incidence of nicks and cuts, without compromising shaving closeness. The primary blade may be quite sharp without significant risk of nicks and cuts due to its negative exposure.

In some alternative embodiments, the tertiary blade, which has the highest level of exposure, may have a tip radius that is equal to or greater than that of the secondary blade. This option is advantageous for users who have a high propensity for nicking and cutting.

In some instances, the primary blade has a tip radius of less than 300 angstroms, e.g., about 235 to about 295, resulting in a cutter force of less than about 1.15 lbs, preferably less than about 1.05 lbs. This is considered herein to be a relatively sharp blade. If it is desired that the primary blade be sharper than the secondary blade, the tip radius of the primary blade may be selected to provide a cutter force of at least about 0.1 lbs lower, preferably at least about 0.4 lbs lower, than the cutter force of the secondary blade. In general, the tip radius of the secondary blade may be from about 600 to about 1000 angstroms, if a quite dull secondary blade is desired, or from about 350 to about 450 angstroms, if it is desired that the secondary blade be only slightly less sharp than the primary blade. A tip radius of 600 to 1000 angstroms will generally produce a cutter force of about 1.75 to 2.0 lbs, whereas a tip radius of 350 to 450 angstroms will generally produce a cutter force of about 1.3 to 1.6 lbs. The tertiary blade may have a tip radius of about 235 to 1000 angstroms, depending on whether it is desired that the tertiary blade be relatively sharper or duller than the other blades.

In other embodiments, it may be desirable to have the primary blade be less sharp than the secondary blade. If the primary blade is less sharp than the secondary blade, the primary blade will tend to pull the hairs further out of the follicle during cutting than a normally sharp blade, so that after cutting the hairs will be further out of the follicle than with a normally sharp blade and thus be cut further down the shaft by the second blade, so that when they retract into the follicles their ends will be beneath the skin surface. For example, the primary blade may have a tip radius of from about 350 to about 450 angstroms, while the secondary blade has a tip radius of from about 235 to about 295 angstroms. In these implementations, the tertiary blade may have the same sharpness as the secondary blade, may be sharper or duller than the secondary blade, or may even be as dull as or duller than the primary blade. Having a relatively dull tertiary blade will tend to give a very safe shave, with little danger of nicking or cutting, while having a relatively sharp tertiary blade will provide a very close shave.

The tip radius R may be varied by controlling the properties of the coatings applied to the blade tip, for example by adjusting the sputtering conditions. The bias on the blades, prior to and/or during sputter deposition, can be varied to effect the etch rate. Generally, blades processed with high bias voltage (e.g., greater than −1000 vdc) yield smaller tip radii and thus lower cutter forces than blades processed at low bias voltages (e.g., less than −200 Volts Direct Current (vdc)). The ion to atom ratio can also be varied to control the deposition and etch rates. Alternatively, the blades may be ion etched post-sputtering to reduce the tip radius. In this case the sputtering conditions would be controlled to provide a high tip radius and then the tip radius would be reduced to a desired level using ion etching. Suitable processes are described in U.S. Pat. No. 4,933,058, the disclosure of which is incorporated herein by reference. Another alternative would be to vary the tip radius by controlling the sharpening process so as to obtain a desired tip radius during sharpening.

If desired, the razor can include four, five or more blades. The blades may have various combinations of sharpness. For example, in a razor having four blades, two blades with higher cutter forces may be positioned to alternate with two blades having lower cutter forces. The blades with the higher cutter forces may be the primary and tertiary blades, or in an alternate embodiment may be the secondary and quaternary blades. In these and other embodiments, the blade(s) having a higher cutter force may in some cases have a tip radius of from about 350 to about 450 angstroms, while the blade(s) having a lower cutter force has a tip radius of from about 235 to about 295 angstroms. In determining the desired degree of sharpness of the various blades, the principles discussed above apply, i.e., a duller blade generally will provide greater safety and will apply tension to hair and pull it from the follicle allowing it to be cut more closely by subsequent blades, while a sharper blade will cut hair more closely and with less cutter force. Generally, providing duller blades in more exposed positions will reduce the incidence of nicks and cuts, while providing sharper blades in these positions will provide a closer, more comfortable shave. It has also been noted by the inventors that for certain women's razors it is generally desirable to provide a sharp blade in the primary position, regardless of the number of blades used. A desired combination of blades of differing sharpness can be determined based on the desired performance attributes of the razor.

A number of embodiments of the invention have been described. Nevertheless, it will be understood that various modifications may be made without departing from the spirit and scope of the invention.

For example, in some implementations the razors may include only two blades. In this case, it is advantageous that the primary blade be duller than the secondary blade. This arrangement allows the primary blade to apply tension to, and lift up, the hairs for the secondary blade to cut more closely.

Accordingly, other embodiments are within the scope of the following claims.

What is claimed is:

1. A razor comprising:
a safety razor blade unit comprising a guard, a cap, and first, second and third blades with parallel sharpened edges located between the guard and cap, the blades having first, second and third tip radii, respectively, at least two of the three blades having different tip radii, wherein the first blade is closest to the guard and has a tip radius greater than the tip radius of at least one of the second and third blades.

2. A razor comprising:
a safety razor blade unit comprising a guard, a cap, and first, second and third blades with parallel sharpened edges located between the guard and cap with the first blade closest to the cap, the third blade furthest from the cap, and the second blade disposed between the first and third blades, the blades having first, second and third tip radii, respectively, at least two of the three blades having different tip radii, wherein the second blade and third blades each have a tip radius greater than the tip radius of the first blade.

3. A razor comprising:
a safety razor blade unit comprising a guard, a cap, and first, second and third blades with parallel sharpened edges located between the guard and cap with the first blade closest to the cap, the third blade furthest from the cap, and the second blade disposed between the first and third blades, the blades having first, second and third tip radii, respectively, at least two of the three blades having different tip radii, wherein the second blade has a tip radius greater than the tip radii of each of the first and third blade.

4. The razor of claim 1, wherein the first blade has a tip radius of from about 235 to 295.

5. The razor of claim 4, wherein the second blade has a tip radius of about 350 to 450.

6. The razor of claim 1, 4 or 5 wherein the third blade has a tip radius of about 235 to 295.

7. The razor of claim 1 wherein the second blade has a tip radius greater than that of the third blade.

8. The razor of claim 1, wherein the third blade has a tip radius greater than that of the second blade.

9. The razor of claim 7 or 8 wherein the first blade has a tip radius greater than that of the second or third blade.

10. The razor of claim 1, wherein the second and third blades have approximately equal tip radii.

11. The razor of claim 1, wherein the first and third blades have approximately equal tip radii.

12. The razor of claim 1, comprising four blades having parallel sharpened edges.

13. The razor of claim 12, wherein the third and fourth blades are positioned in third and fourth positions from the guard respectively.

14. The razor of claim 13, wherein the fourth blade has a greater tip radius than the third blade.

15. The razor of claim 13, wherein the tip radius of the third blade is approximately equal to the tip radius of the first blade and the tip radius of the second blade is approximately equal to the tip radius of the fourth blade.

16. The razor of claim 2 wherein the tip radius of the second blade is greater than the tip radius of the third blade.

17. The razor of claim 2, comprising four blades having parallel sharpened edges, wherein the third and fourth blades are positioned in third and fourth positions from the guard respectively.

18. The razor of claim 17, wherein the fourth blade has a greater tip radius than the third blade.

19. The razor of claim 17, wherein the tip radius of the second blade is approximately equal to the tip radius of the fourth blade.

20. The razor of claim 3 comprising four blades having parallel sharpened edges, wherein the third and fourth blades are positioned in third and fourth positions from the guard respectively.

21. The razor of claim 20, wherein the fourth blade has a greater tip radius than the third blade.

22. The razor of claim 20, wherein the tip radius of the third blade is approximately equal to the tip radius of the first blade and the tip radius of the second blade is approximately equal to the tip radius of the fourth blade.

23. The razor of claim 1, 2 or 3 wherein the blades have different blade exposures.

24. The razor of claim 20 comprising a fifth blade positioned in a fifth position relative to the guard.

25. A method of making a razor, the method comprising;
treating a first blade to provide a tip having a first radius of curvature;
treating a second blade to provide a tip having a second radius of curvature;
treating a third blade to provide a tip having a third radius of curvature;
wherein at least two of the radii of curvature are different; and
assembling the first, second and third blades in a cartridge comprising a guard and a cap, wherein the blades are positioned having parallel edges and have different blade exposures.

26. A method of shaving, the method comprising;
providing a safety razor blade unit comprising a guard, a cap, and first, second and third blades with parallel sharpened edges located between the guard and cap, the blades having first, second and third tip radii, respectively, at least two of the three blades having different tip radii, wherein the first blade is closest to the guard and has a tip radius greater than the tip radius of at least one of the second and third blades; and
contacting a skin surface with the safety razor blade unit.

27. A method of shaving, the method comprising;
providing a safety razor blade unit comprising a guard, a cap, and first, second and third blades with parallel sharpened edges located between the guard and cap with the first blade closest to the cap, the third blade furthest from the cap, and the second blade disposed between the first and third blades, the blades having first, second and third tip radii, respectively, at least two of the three blades having different tip radii, wherein the second blade and third blades each have a tip radius greater than the tip radius of the first blade; and
contacting a skin surface with the safety razor blade unit.

28. A method of shaving, the method comprising;
providing a safety razor blade unit comprising a guard, a cap, and first, second and third blades with parallel sharpened edges located between the guard and cap with the first blade closest to the cap, the third blade furthest from the cap, and the second blade disposed between the first and third blades, the blades having first, second and third tip radii, respectively, at least two of the three blades having different tip radii, wherein the second blade has a tip radius greater than the tip radii of each of the first and third blade; and
contacting a skin surface with the safety razor blade unit.
